(19) United States
(12) Patent Application Publication
(10) Pub. No.: US 2026/0355731 A1
(43) Pub. Date: Nov. 12, 2026

(54) SYSTEMS AND METHODS FOR CATALYTIC CONTROL DEVICES

(71) Applicant: BLUE ORIGIN MANUFACTURING, LLC, Huntsville, AL (US)

(72) Inventors: Pablo Arias Vecino, Seattle, WA (US); Mitchell Ryan, Covington, WA (US); Thomas M. Walczuk, Maple Valley, WA (US); Stephen M. Walton, Seattle, WA (US); Justin P. Volpe, Broken Arrow, OK (US)

(21) Appl. No.: 19/205,514

(22) Filed: May 12, 2025

(51) Int. Cl. B01J 37/03; B01J 23/89; B01J 37/00

(52) U.S. Cl. CPC B01J 37/038; B01J 23/8906; B01J 37/0018; B01J 2531/828; B01J 2531/842

(57) ABSTRACT

Systems and methods are directed toward a catalyst assembly that may be used in one or more process streams. The catalyst assembly may be formed by applying a washcoat slurry to a substrate. The application of the washcoat slurry may include a push/pull process that enables higher loading while maintaining flow channels associated with the substrate.

### TECHNICAL FIELD

Developments herein relate generally to systems and methods which may include application of catalytic materials to one or more substrates to form a catalyst assembly to be used within a process stream.

### BACKGROUND

Process control devices may be used to convert one or more components of a process stream via chemical interaction. Catalytic control devices may include one or more substrates that are made of or otherwise coupled to one or more catalytic materials that may chemically interact with the one or more components of the process stream to convert the one or more components into a different component. The catalytic control devices may be passive devices that are arranged within a process stream. For example, a substrate or monolith may be formed of a particular material, may be coated with one or more catalytic materials, and/or may hold or otherwise support one or more catalytic materials that may interact with the process stream as the process stream moves through the catalytic control device. Catalytic control devices may be particularly selected for a target process stream, target operating conditions, and/or the like. Certain operating conditions may be more challenging to control, due to process stream concentrations, flow rates, and/or the like. As a result, catalytic control devices may have prohibitively short life spans, may be ineffective at converting process streams, and/or may restrict or change performance associated with the process streams.

### SUMMARY

Developments described herein may include catalyst assemblies that have been coated utilizing a high cell density substrate, resulting in more reactivity from one or more catalytic materials. Higher substrate cell densities, and the resulting increased reactivity, may enable higher bed loading and longer lasting catalyst assemblies. Systems and methods may be directed toward receiving and inspecting one or more substrates, forming a washcoat slurry, applying the washcoat slurry to the substrate to form a catalyst assembly, and positioning the catalyst assembly within a process stream to convert one or more components of the process stream via chemical reaction between the catalyst assembly and the process stream.

One or more embodiments address and overcome problems with catalyst assemblies that are unable to achieve sufficient metal loading (e.g., sufficient area loading, washcoat loading, etc.), which leads to lower reactivity and/or shorter life. Systems and methods may be applicable to substrates that are formed with a high channel density due to one or more wash slurry preparation processes, which may include milling particle sizes to a target size (e.g., below one or more thresholds), along with one or more tuning processes to achieve one or more target rheological properties in order to both provide a consistent condition of the washcoat to avoid clogging substrate channels while also loading a sufficient quantity of washcoat to enable higher levels of reactivity. Embodiments may further implement a coating process that pushes the washcoat slurry through the substrates and then subsequently pulls excess washcoat away. Accordingly, systems and methods of the present disclosure may be used to provide a catalyst assembly with a higher number of effectively coated channels (e.g., channels having a sufficient or target metal or catalyst loading).

One or more embodiments may be directed toward washcoat catalyst processing that may be used for one or more product streams, which may include as a non-limiting example, an exhaust process stream from one or more engines, such as a hydrogen peroxide thruster. The washcoat catalyst processing may include forming a slurry and then applying the slurry to one or more substrates. The coating process used herein may enable substrate coating with high cell densities, resulting in more reactivity from the catalytic material associated with the washcoat. In certain applications, increasing reactivity may enable higher bed loading and longer lasting catalysts. One or more embodiments address and overcome problems with existing catalytic systems and methods by providing a higher channel density to provide higher loading. Systems and methods may be directed toward a coating process that operates with substrates having a high channel density, which may include at least a milling process to prepare the slurry and the washcoating process. For example, one or more milling processes may be used to form catalyst particles having a target size that may be mixed and tuned in order to bring slurry rheology (yield stress) into a consistent condition. Accordingly, the coating process used herein may not clog substrate components while still providing sufficient coverage and washcoat loading. As discussed herein, an application process may include a push/pull configuration in which slurry is pushed through one or more channels or areas of a substrate and then excess slurry is pulled away from the substrate. Additionally, one or more embodiments may include a partial vacuum system to apply a rush of air through one or more portions of the substrate to open any channels or gaps without stripping the coating, thereby maintaining high catalyst loading. That is, a target or desired coating thickness, or at least a threshold amount of coating thickness, may remain along the channels after the partial vacuum system applies the air. Accordingly, systems and methods of the present disclosure enable high reactions within a fixed volume of space due to the high density of catalytic material.

Various embodiments are directed toward one or more methods for forming a catalyst assembly that may be used with one or more process streams. The one or more methods may include milling a catalytic wash powder to a target particle distribution and then combining the milled catalytic wash powder with one or more additives. Embodiments may also include tuning the combined catalytic wash powder and one or more additives, which may be based on a variety of factors, such as one or more rheological properties. After tuning, a washcoat slurry may be formed that may then be used to coat one or more channels of a substrate. Excess washcoat slurry may be removed from the one or more channels and then one or more heating processes may be used to form a catalyst assembly. As discussed herein, the washcoat slurry may include at least one of a gamma-aluminum oxide powder, a platinum metal group active catalyst, nitric acid, an aluminum oxide hydroxide suspension, or samarium nitrate hexahydrate. Prior to applying the washcoat slurry, the one or more methods may also include cleaning and/or oxidizing a surface of the substrate. In at least one embodiment, the one or more channels may refer to corrugations formed within a base plate used to form the substrate. Application of the washcoat slurry may be done using a push/pull process in which a coating assembly is at least partially filled with the washcoat slurry, the substrate is positioned within the coating assembly, a shear force is used to drive the washcoat slurry along the one or more channels, and then a vacuum force is used to remove the excess substrate.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. It will be readily understood that the aspects of the present disclosure, as generally described herein, and illustrated in the figures, can be arranged, substituted, combined, and designed in a wide variety of different configurations, all of which are explicitly contemplated and make part of this disclosure. As noted above, the drawings as depicted are not necessarily drawn to scale. The relative dimensions and proportions as shown are not intended to limit the present disclosure, unless indicated otherwise. Various embodiments in accordance with the present disclosure will be described with reference to the drawings, in which:

FIG. 1A illustrates an example process flow diagram for forming a catalyst assembly using catalytic materials and a substrate, according to at least one embodiment;

FIG. 1B illustrates an example process flow diagram for generating thrust via a reaction using a catalyst assembly, according to at least one embodiment;

FIG. 2A illustrates an example process flow diagram for forming a washcoat slurry, according to at least one embodiment;

FIG. 2B illustrates an example process flow diagram for inspecting and preparing a substrate, according to at least one embodiment;

FIG. 2C illustrates an example process flow diagram for forming a catalyst assembly using a washcoating process, according to at least one embodiment;

FIG. 3 illustrates an example sequence for performing a washcoating process, according to at least one embodiment;

FIG. 4 illustrates a schematic representation of a washcoated substrate, according to at least one embodiment;

FIG. 5A illustrates an example process for forming and inspecting a catalyst assembly, in accordance with at least one embodiment;

FIG. 5B illustrates an example process for forming a catalyst assembly, in accordance with at least one embodiment; and

FIG. 5C illustrates an example process for forming and inspecting a catalyst assembly, in accordance with at least one embodiment.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. It should be further appreciated that terms such as approximately or substantially may indicate +/−10 percent.

Systems and methods are directed, at least in part, toward a catalyst formation process that may include forming a catalytic slurry, washcoating a substrate, and then forming a catalyst assembly (e.g., catalyst, catalytic structure, etc.) that may be used in one or more process streams, including but not limited to, a propulsion system used by one or more launch vehicles. The catalyst assembly formation process may include one or more steps or actions to generate a catalytic slurry that may be applied to a substrate to form a catalyst assembly that has a high loading/high density to facilitate catalytic process control, which may include chemically converting one or more elements or components, for example to create thrust, to control pollutant emissions, and/or combinations thereof. One or more embodiments may include a slurry formation process that may include, at least in part, process steps or actions to obtain or provide a dry powder, mill the dry powder, add one or more additives to the milled dry powder, and then tune the mixture to obtain a target rheological composition (e.g., elastic behavior, viscous behavior, plastic behavior, etc.). One or more embodiments may also be directed toward one or more washcoating applications to apply the catalytic slurry to a substrate such that the substrate, with the included catalytic slurry, which may collectively be referred to as a catalyst assembly, may be installed within or associated with one or more process streams in order to react with one or more compounds within the process stream. In one non-limiting example, the process stream may be associated with a propulsion device, such as an engine, that may receive, as an input, a propellant that reacts with the catalytic materials of the catalyst assembly to generate thrust along with one or more byproducts. Accordingly, embodiments may be directed toward formation of catalyst assemblies that may be used in one or more process streams.

As used herein, a catalyst assembly may refer to an object or structure that is installed within or associated with one or more process streams. The catalyst assembly may also be referred to as a catalyst and/or a catalytic structure that may include a substrate (e.g., monolith) and a catalytic material associated with the substrate. The catalytic material may be bound to the substrate and/or may be an integral part of the substrate. For example, the substrate itself may contain one or more catalytic materials. As used herein, catalytic material may refer to a substance that increases a rate of or causes a chemical reaction without being consumed by the chemical reaction.

One or more embodiments of the present disclosure may be directed toward one or more processes for generating a catalyst assembly that may include processes, steps, or actions including receiving, inspecting and preparing a substrate; preparing a catalytic slurry; applying at least a portion of the catalytic slurry to the substrate; performing one or more post-treatment actions on the catalyst assembly formed by the combination of the catalytic slurry and the substrate; and/or inspecting the catalyst assembly. Embodiments may further include using or causing use of the catalyst assembly in one or more process streams, which may include a process stream associated with a launch vehicle engine.

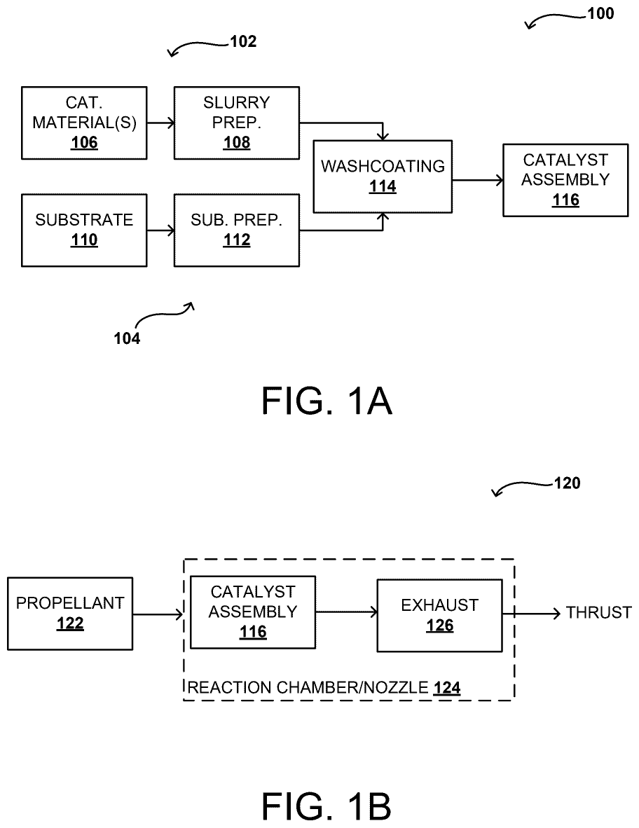

FIG. 1A illustrates an example process flow diagram 100 that may be used with various embodiments of the present disclosure. The illustrated process flow diagram 100 has omitted various components for simplicity with the present discussion, including features such as sensors (e.g., pressure sensors, temperature sensors, flow sensors, etc.), fluid movers (e.g., pumps, compressors, etc.), various valves, and/or the like. In this example, the process flow diagram 100 includes a first train 102 and a second train 104, which may be performed at least partially in parallel. The first train 102 is associated with a catalyst material preparation process while the second train 104 is associated with a substrate preparation process. However, one or more operations and/or processes within one or both of the first train 102 and/or the second train 104 may be used with the other of the first train 102 and/or the second train 104. By way of example, a heater may be used in each of the first train 102 and/or the second train 104. Additionally, one or more inspection or evaluation techniques or tools may also be used in one or both of the first train 102 and/or the second train 104.

Turning to the first train 102, embodiments may be directed toward preparing a washcoat slurry including one or more catalytic materials 106. The catalytic materials 106 may be particularly selected based on a target process stream for the catalyst assembly. As one non-limiting example, for use within a launch vehicle thruster that uses a hydrogen peroxide input, systems and methods may be used to form a washcoated monolithic bed capable of catalytically decomposing hydrogen peroxide for propulsion and pressurization applications. The one or more catalytic materials 106 may include an alumina-based matrix with integrated platinum group metal (PGM) active catalyst. The one or more catalytic materials 106 may include one or more components or compounds to generate a catalytically active washcoat, which may include materials that facilitate one or more chemical reactions and/or supporting materials, as discussed herein.

In operation, the one or more catalytic materials 106 may undergo one or more slurry preparation processes 108, which may include mixing, milling, chemical additions, tuning, and/or combinations thereof. The one or more slurry preparation processes 108 may be used to generate a catalytically active washcoat that has one or more target rheological properties, which may refer to viscosity of the washcoat slurry, among other properties.

The illustrated second train 104 includes receipt of a substrate 110, which may also be referred to herein as a monolith. The substrate 110 may include one or more materials or alloys, which may include as one non-limiting example ferroalloys, such as an alloy of chromium and iron, among other examples. The substrate 110 may be formed from one or more sheets into a corrugated configuration to provide a target or specified surface area. The formation of the substrate 110 into the target configuration may be performed during one or more substrate preparation processes 112, which may further include steps such as inspection, calibration, washing, cleaning, pre-oxidizing, and/or the like.

The prepared substrate 110 and the catalytic slurry may then be used during one or more washcoating processes 114. The one or more washcoating processes 114 may be used to apply the slurry (e.g., the combination of the one or more catalytic materials 106) to the surface of the substrate 110. A push/pull and/or vacuum process may be used to drive the slurry into channels of the substrate 110 and then remove the excess slurry, causing the remaining slurry to be maintained on the substrate 110 as a high viscosity fluid. In embodiments, the substrate 110 may include one or more channels that also include a layer of the washcoat slurry, while still providing sufficient cross-sectional area to enable flow of the process stream, which as discussed herein, may include a gas, liquid, solid, or combinations thereof. After the washcoating process 114, which may include multiple steps such as coating, drying, heat treating, and/or the like, a catalyst assembly 116 may be formed as a combination of the substrate 110 and the slurry. The catalyst assembly 116 may then be used in one or more process streams to facilitate and/or regulate one or more chemical reactions.

One or more embodiments of the present disclosure may be used to generate the catalyst assembly 116 for use as a washcoated monolithic bed capable of catalytically decomposing hydrogen peroxide for propulsion and pressurization applications. A catalytic washcoat may be formed as a slurry-derived high surface area coating, composed of an alumina-based matrix with integrated PGM active catalyst. This coating may be applied on oxidized metallic substrates. One or more embodiments may include specific chemical compositions specifically designed to decompose MIL-PRF-16005F Type 90, grade HP hydrogen peroxide above 50 °F. However, other target process streams with different catalyst compositions may be used within the scope and content of the present disclosure for various applications, including at least, but not limited to, propulsion, power generation, combustion regulation, and/or combinations thereof.

FIG. 1B illustrates an example process flow diagram 120 that may be used with embodiments of the present disclosure directed toward propulsion systems, such as propulsion systems used with launch vehicles, among other options. The illustrated example includes a propellant 122 that may be directed toward a reaction chamber/nozzle 124. For example, the propellant 122 may be hydrogen peroxide, among other options, and may be in the form of a gas, liquid, solid, or combinations thereof. In operation, the catalyst assembly 116 within the reaction chamber/nozzle 124 may be particularly selected to decompose the propellant 122 into one or more fluids or mixtures (e.g., steam, oxygen, etc.) in the form of exhaust 126, which may be used to produce thrust. As discussed herein, the exhaust 126 may also, or alternatively, be used for other purposes, such as to drive a turbine, heat a fluid, and/or combinations thereof.

In at least one embodiment, such as a launch vehicle propulsion system that uses a hydrogen peroxide fuel, the flow of propellant to the catalyst may be in the form of a liquid and the catalyst assembly may be used to convert the liquid into a gas at a high flow rate of between approximately 15 and 19 pounds per second (lbm/s). In one or more embodiments, the high flow rate may produce between approximately 1,900 pounds of thrust to 2,500 pounds of thrust. Furthermore, feed of the liquid may be approximately 0-30 degrees Celsius (°C).

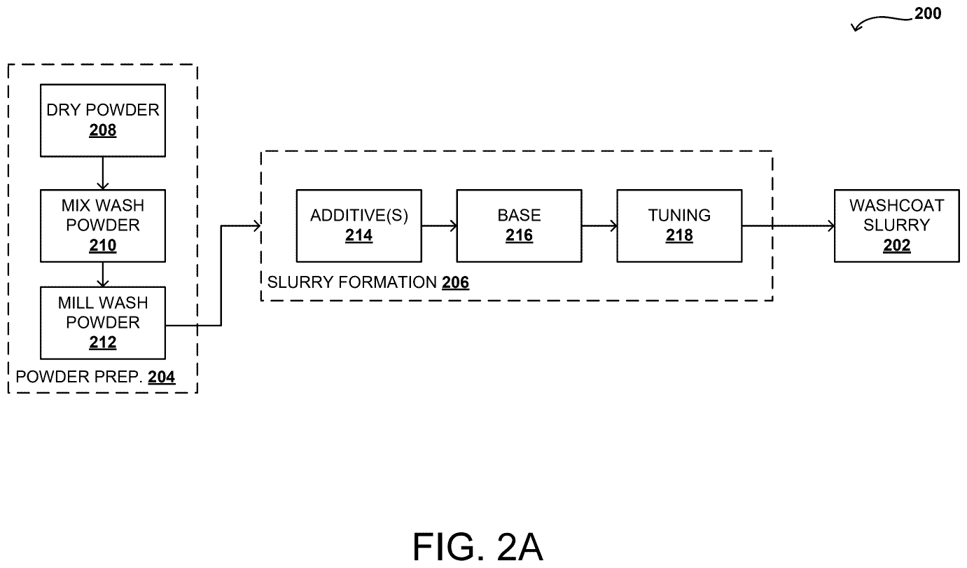

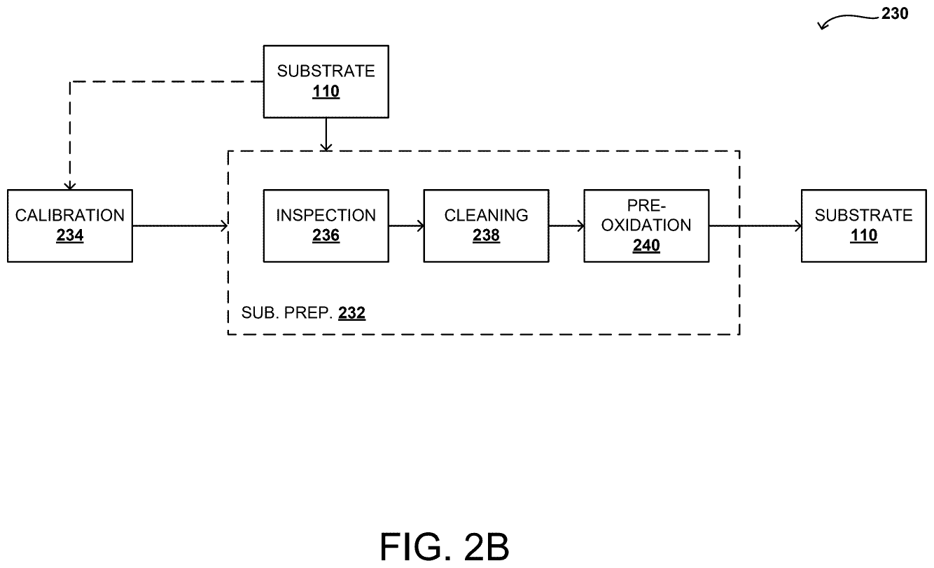

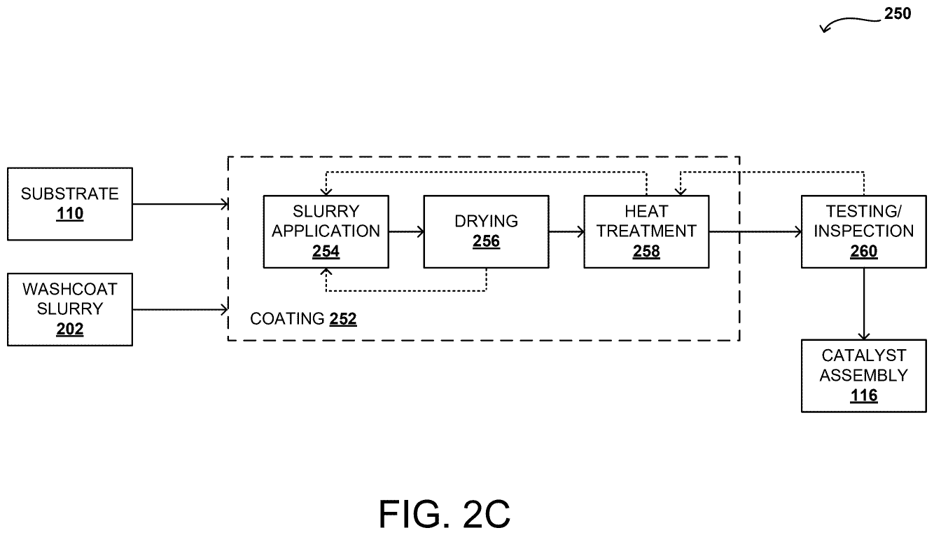

FIG. 2A illustrates an example process flow diagram 200 that may be used with embodiments of the present disclosure. In one or more embodiments, systems and methods may be used to generate a washcoat slurry 202 that may be used to form one or more catalyst assemblies that may be used within one or more process streams. In this example, the washcoat generation includes powder preparation 204 and slurry formation 206. It should be appreciated that the steps and/or actions are separated for convenience and that one or more steps or portions may be combined with other processes. For example, powder preparation itself may be considered a step for generating the slurry formation. Additionally, one or more steps or actions may be omitted, such as pre-sourcing milled wash powder for use with slurry formation.

One or more embodiments may be used to form a combination of gamma-aluminum oxide (doped or undoped) and pseudo-boehmite aluminum oxyhydroxide to serve as a basis of the washcoat. An acid environment may be preferable to prevent agglomeration of the aluminum oxide particles. As discussed herein, PGM precursors are then added to obtain a final catalytically active washcoat. The washcoat slurry 202 may be formed by one or more of the components shown in Table 1. Systems and methods may also limit or otherwise omit certain components from the washcoat slurry 202, such as chlorinated compounds, due to poisoning of active sites. Furthermore, the use of silicones or other organic resins may be omitted from the washcoat slurry 202.

TABLE 1
Washcoat Ingredients

| Component | Mass ratio |
|---|---|
| Gamma-aluminum oxide powder | 600-1830 |
| Deionized water | 600-2800 |
| Nitric acid | 10-80 |
| Aluminum oxide hydroxide suspension | 140-480 |
| Platinum nitrate | 300-900 |
| Samarium nitrate hexahydrate | 20-65 |
| Tetramethylammonium hydroxide (TMAOH) | 200-2000 |

In this example, powder preparation 204 includes one or more steps that may include obtaining dry powder 208, mixing a wash powder 210, and milling the wash powder 212. The initial powder may refer to the gamma-aluminum oxide powder discussed herein. Thereafter, the dry powder 208 may be mixed using one or more mixers to provide a uniform distribution or to otherwise prevent clumping or other undesirable properties of the dry powder 208. In one or more embodiments, the gamma-alumina powder may be dried, either before or after mixing, for a period of time, which may be approximately two hours at 200 Celsius (°C). Thereafter, milling the wash powder 212 may reduce the particle size of the received aluminum oxide to obtain a desired particle size distribution for the washcoat. The particle distribution may vary based on the target application of the washcoat, such as properties of the substrate, properties of the process stream, and/or combinations thereof. In one or more embodiments, a selected mill may be capable of processing particles with an average size of particles in the distribution (D50) starting at or above 20 μm and to grind the material to D50 of approximately 1 μm in a wet dispersed environment. In one or more embodiments, the resultant particles may be less than or equal to 1 μm in a wet dispersed environment. As discussed herein, the milling of the wash powder may occur under acidic conditions and may further include active cooling.

In operation, dried gamma-alumina powder may be milled to obtain a target particle size distribution in the range for effective coating onto the substrate. One or more embodiments may include a wet milling process in which the powder has been dispersed on acidic water, for example as part of the mixing wash powder 210 process. The pH of the mixed wash powder may be monitored periodically, for example using one or more sensors and/or by pulling samples at periodic times, and may be controlled to be less than approximately a pH of 6. Particle size distribution may also be monitored periodically throughout the milling process. Upon completion of the milling process, the milled wash powder may have properties shown in Table 2.

TABLE 2
Milled Wash Powder Size

| Property | Unit | Min | Max |
|---|---|---|---|
| pH | — | 4 | 5.5 |
| Specific gravity | — | 1.20 | 1.60 |
| D10 | μm | 0.01 | 0.7 |
| D50 | μm | 0.8 | 1.2 |
| D90 | μm | 2.0 | 7.0 |

The milled wash powder is then used in the slurry formation process 206, which may be used to form the washcoat slurry 202 used to coat the substrate. In one or more embodiments, the slurry formation process 206 may include the addition of one or more additives 214. Additives may include a variety of different materials, such as aluminum oxide hydroxide, samarium nitrate, and/or others. The use of the one or more additives 214 may be performed under low shear mixing. An aging period may also be included for the additives, which may be between 30 minutes and 2 hours, as non-limiting examples. Furthermore, inclusion of a binder may be performed under low shear mixing prior to using higher shear mixing in order to obtain uniform dispersion of PGM precursor solution in the acidic slurry. For example, a platinum precursor solution may be incorporated into the mixture after the aging period, and may be added as part of the additive step 214 or with the one or more binders. The mixture must be subject to high shear for dispersion of the active catalyst ingredient on the aluminum oxide. Supplementary additives, such as samarium nitrate, may also be incorporated. In one or more embodiments, samarium nitrate may be omitted where the additive precursor is in alkaline form. Additional aging processes may also be incorporated, which may be approximately 3 hours, as a non-limiting example.

Embodiments may also include the addition of base 216 with one or more slurry modifiers, which may be performed under active mixing. Deionized water may also be included in the slurry. One or more embodiments may actively measure and/or monitor the slurry to measure rheology properties. Furthermore, tuning 218 may also be performed in order to obtain desired properties for the washcoat slurry 202.

In at least one embodiment, the slurry may have one or more properties according to Table 3.

TABLE 3
Slurry Properties

| Property | Unit | Min | Max |
|---|---|---|---|
| pH | — | 3.3 | 4.5 |
| Specific gravity | — | 1.2 | 1.6 |
| Yield stress | Pa | 0.8 | 5 |

In one or more embodiments, the formulation for the washcoat slurry may have one or more properties according to Table 4.

TABLE 4
Slurry Chemical Ratios

| Property | Range |
|---|---|
| Binder mass ratio | 19.0-21.0 |
| Samarium mass percentage | 1.0-1.2 |
| Platinum mass percentage | 6.5-15.5 |
| Base-to-acid molar ratio | 0.26-0.85 |

As used herein, the binder mass ratio may be defined by Equation (1):

$$\frac{{w}_{DGAP}}{{w}_{AOHs}} \times {K}_{1} , \qquad ( 1 )$$

where w_{DGAP} is the weight of dry gamma alumina powder in grams, w_{AOHS} is the weight of aluminum oxide hydroxide suspension in grams, and the constant K₁ is between approximately 4 and approximately 6.

As used herein, the samarium mass percentage may be defined by Equation (2):

$$\frac{{w}_{SNH}}{{w}_{DGAP}} \times {K}_{2} , \qquad ( 2 )$$

where w_{SNH} is the weight of samarium nitrate hexahydrate in grams and the constant K₂ is between approximately 30 and approximately 35.

As used herein, the platinum mass percentage may be defined by Equation (3):

$$\frac{{w}_{PNS} \times ( WT \% ) \times 100}{( total solid s )} , \qquad ( 3 )$$

where w_{PNS} is the weight of platinum nitrate solution in grams, WT % is defined per solution lot as a weight percentage according to Equation (4), where wp is the weight of platinum in grams, and total solids is defined by Equation (5), where the constant K₃ is between approximately 0.05 and approximately 0.1.

$$\frac{{w}_{p}}{( {w}_{PNS} ) \times 100} , \qquad ( 4 )$$

$$( {W}_{DGAP} + {W}_{PNS} + {W}_{AOHS} + {W}_{SNH} ) \times {K}_{3} . \qquad ( 5 )$$

As used herein, the base-to-acid molar ratio may be defined by Equation (6):

$$\frac{{w}_{TMAOH}}{\frac{{NO}_{3}}{Pt} \times {w}_{PNS} \times WT \% + {w}_{SNH} + 2 \times {w}_{NA}} \times {K}_{4} , \qquad ( 6 )$$

where w_{TMAOH} is the weight of TMAOH in grams, w_{NA} is the weight of nitric acid in grams, NO₃/Pt is the nitrate-to-platinum ratio defined as moles of nitrate ion divided by moles of platinum, and the constant K₄ is between approximately 1 and approximately 3.

In certain embodiments, the slurry may be generated using one or more different methods. For example, a first method may be associated with a legacy washcoat product for hydrogen peroxide conversion that may be used for applications such as new monolith structures or raw materials. A second method may be associated with a washcoat product for hydrogen peroxide conversion, with support for both low and high flow rate demand operations, that may be used in applications such as thrusters. In certain embodiments, the platinum mass percentage for the first method may be between approximately 6.5 and 7.5 percent while the platinum mass percentage for the second method may be between approximately 14.5 and 15.5 percent. Similarly, the base-to-acid molar ratio may be between approximately 0.67 and 0.85 for the first method and between approximately 0.32 and 0.58 for the second method. Final slurry properties may also be dependent, at least in part, on the methods. For example, the ranges for the first method may be approximately 3.8 to 4.5 for pH, approximately 1.2 to 1.5 for specific gravity, and approximately 0.8 to 1.5 Pa for yield stress, while the second method may be approximately 3.3 to 3.7 for pH, approximately 1.35 to 1.6 for specific gravity, and approximately 1.5 to 5 Pa for yield stress.

FIG. 2B illustrates an example process flow diagram 230 that may be used with embodiments of the present disclosure. In one or more embodiments, the substrate 110 may be prepared for a washcoating process after one or more evaluation and/or preparation operations. In this example, a substrate preparation process 232 may be performed in order to prepare the substrate 110 in advance of one or more washcoating processes. One or more tools or different equipment may be used during the substrate preparation process 232, which may include equipment such as cleaners, ovens, furnaces, dryers, analysis tools, and/or the like. A calibration process 234 may be performed in advance of the substrate preparation process 232, which may include calibrating or adjusting the equipment based, at least in part, on properties of the substrate 110. For example, different materials may include different evaluation and/or inspection steps. As one non-limiting example, material quality may be evaluated by determining whether a metallic substrate is magnetic and, if a non-magnetic material is desired, the determination of magnetism may be used to reject or otherwise use different substrate materials. As another example, if the substrate were a stainless steel, water used in one or more processes may be evaluated for chloride content to reduce a likelihood of stress cracking in downstream processes. Accordingly, different calibration steps may be used, at least in part, on the material associated with the substrate 110 and/or on one or more target downstream operations.

As shown, the substrate 110 may be inspected 236, for example to look for deformations/damage and/or to evaluate a composition of the substrate 110. In at least one embodiment, the substrate may be composed of a FeCr Alloy, which may be in the form of a sheet that may then be worked into a corrugated pattern. The substrate 110 may have one or more properties according to Table 5.

TABLE 5
Substrate Properties

| Element | Min (wt %) | Max (wt %) |
|---|---|---|
| Aluminum | 4.0 | 6.5 |
| Chromium | 16 | 25 |
| Yttrium | 0.8 | 0.5 |
| Other elements | | 0.03 |

| | |
|---|---|
| Iron | balance |

Inspection 236 may also include one or more additional process steps and subsequent inspection of those steps, including but not limited to, shaping into a desired size, brazing, coiling, and/or the like. For example, corrugation may be used to form the substrate to have a target surface area value of cells per square inch. Additionally, in one or more embodiments, brazing of the foil structure may provide additional structural robustness, while still accounting for the formation of “whiskers” that may be hindered due to nickel alloy braze materials. As discussed herein, the substrate 110 receives and maintains the washcoat.

Upon passing inspection 236 (e.g., free from scratches, free from dents, minimum count of open channels, etc.), the substrate 110 may then be cleaned 238. Cleaning may include surface cleaning to prepare for subsequent pre-oxidation 240. For example, the substrate 110 may undergo one or more surface cleaning processes to ensure the surface is free from dirt or other debris. Cleaning may include an alkaline clean step, a water rinse step, and a drying step. Additionally, one or more embodiments may further include surface preparation operations, such as an acid foil treatment for surface etching with a nitric acid solution (approx. 30% vol.).

One or more embodiments may also include the pre-oxidation process 240 prior to addition of the washcoat in forced air flow. Pre-oxidation may be performed for approximately 12 hours in a furnace or oven between 900 °C and 1050 °C. For example, an oxidation furnace configured to operate an oxygen atmosphere of up to 20% vol may be used. An active flow rate in the furnace may provide efficient oxidation of uncoated substrates. Accordingly, the substrate 110 may be prepared for washcoating.

FIG. 2C illustrates an example process 250 for applying the washcoat slurry 202 to the substrate 110 to produce the catalyst assembly 116, which may be used in embodiments of the present disclosure. The illustrated example includes a coating process 252, which may include one or more steps or sub-steps, which as discussed herein, may be repeated to obtain a target level of catalytic activation for the catalyst assembly 116. In the example, the coating process 252 includes steps for slurry application 254, drying 256, and heat treatment 258.

One or more embodiments may include a coater system for the slurry application 254 that is particularly selected for a dipping process that is used to apply the washcoat slurry 202 to the substrate. Using the dipping process, the slurry may be subjected to active shear and flowed through the monolith parts. The rheological properties of the slurry are thus utilized for substantially uniform deposition on the substrate channels. Moreover, the coater system may be controllable and adaptable to different substrate configurations. As discussed herein, the coater system may use a push/pull configuration in which the washcoat slurry is flowed through the channels of the substrate and then a vacuum may pull the excess washcoat slurry away from the substrate, thereby coating the surface of the substrate.

As discussed herein, a washcoat technique may be used to apply the washcoat slurry 202 to the oxidized surface of the substrate 110. Slurry rheological behavior may require shear to be applied to flow the slurry through the substrate (e.g., through channels in the substrate), coating the substrate, and remaining in the channels as a high viscosity fluid. Excess slurry is then removed in a vacuum. Layer thickness per slurry fill is dependent on specific formulation and rheology of the sample, cell density, and surface roughness of the substrate. In at least one embodiment, the washcoat slurry 202 may be mixed to form a homogeneous suspension prior to loading into the coater system. The coater system may include a piston-cylinder arrangement in which the washcoat slurry 202 is pushed through the substrate 110 to flood the channels. Excess washcoat slurry 202 may then be removed using, for example, vacuum suction.

To measure application of the washcoat slurry 202, a weight may be obtained of the substrate 110 before and after loading to determine applied washcoat, which may be defined by Equation (7):

$$\frac{mass on last coat after excess removal - mass uncoated substrate}{mass uncoated substrate} . \qquad ( 7 )$$

In one or more embodiments, applied washcoat on the substrate, in gram per gram of substrate may have one or more properties according to Table 6.

TABLE 6
Applied Washcoat

| | Min | Max |
|---|---|---|
| First Method | 0.07 | 0.13 |
| Second Method | 0.130 | 0.220 |

Similarly, in at least one embodiment, application of the washcoat slurry 202 may be discussed with respect to surface area of the parts, instead of or in addition to mass, which may account for variations in cell density. In one or more embodiments, applied washcoat on the substrate, in gram per square meter units, may have one or more properties according to Table 7.

TABLE 7
Applied Washcoat

| | Min | Max |
|---|---|---|
| First Method | 25 | 60 |
| Second Method | 60 | 110 |

Reworking may occur, as shown by the dashed lines, if the weight on the substrate 110 is lower than expected. However, if the weight exceeds the max values in Table 6, the substrate 110 may be deemed non-conforming and subsequently rejected.

Drying 256 may include the use of air flow dryers or the like for de-watering of the washcoat slurry 202, which may enhance retention on the substrate 110 and maintain the channels. As shown, after drying 256, an additional slurry application process 254 may be executed with subsequent drying 256, and/or heat treatment 258 (e.g., calcination) operations performed in various embodiments. In operation, an air operation may be used for heat treatment of the coated substrate 110 after drying to maintain specific coat thickness control, avoid channel blockage, and maintain overall material adhesion.

During heat treatment, the aluminum hydroxide binder reacts with the alumina particles promoting adhesion of the coating to the substrate 110. Calcination enables the decomposition of PGM precursors and their conversion to the active oxide species responsible for hydrogen peroxide decomposition. Coated substrates that pass loading evaluations may be heat treated under air flow circulation to accomplish calcination of the ceramic coating. Heating may occur within range of approximately 600 °C and 760 °C for approximately 30 min to 3 hours. Additionally, a final reduction passivation treatment may also be performed. Subsequently, further testing and inspection 260 may be performed, such as evaluating weight, microstructure, open channel count, and/or the like. In one or more embodiments, if testing fails, then the catalyst assembly 116 may be discarded. However, in certain embodiments, testing or inspection may lead to one or more additional heat treatment processes. Accordingly, systems and methods of the present disclosure may be used to load the washcoat slurry 202 onto the substrate 110 to produce the catalyst assembly 116.

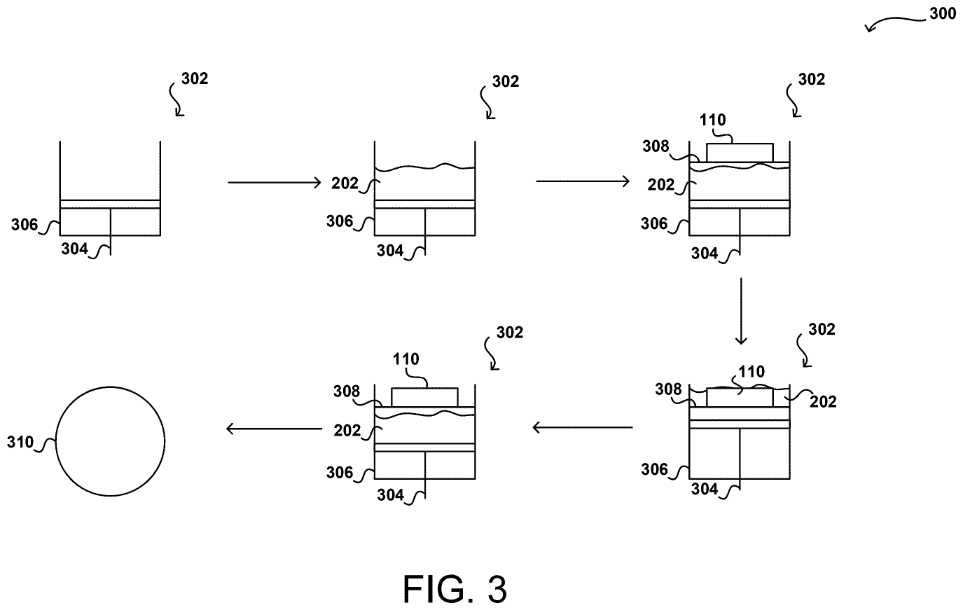

FIG. 3 illustrates an example sequence 300 that may be used with embodiments of the present disclosure to apply a washcoat slurry to a substrate. In this example, a coating system 302 includes a piston 304 and a cylinder 306 arrangement that is configured to receive the washcoat slurry 202. As shown, the piston 304 may be retracted within the cylinder 306 and then the washcoat slurry 202 may be added to the cylinder 306. Thereafter, the substrate 110 is positioned within the cylinder 306, for example on a support 308, and the piston 304 is advanced to drive the washcoat slurry 202 through the channels of the substrate 110. While not illustrated in FIG. 3, the cylinder 306 may include a cap or cover, or may otherwise be pressurized. The piston 304 may then be retracted to remove excess washcoat from the substrate 110, for example using a vacuum, to generate a coated substrate 310, which may then undergo one or more drying and/or heat treating processes to form the catalyst assembly 116.

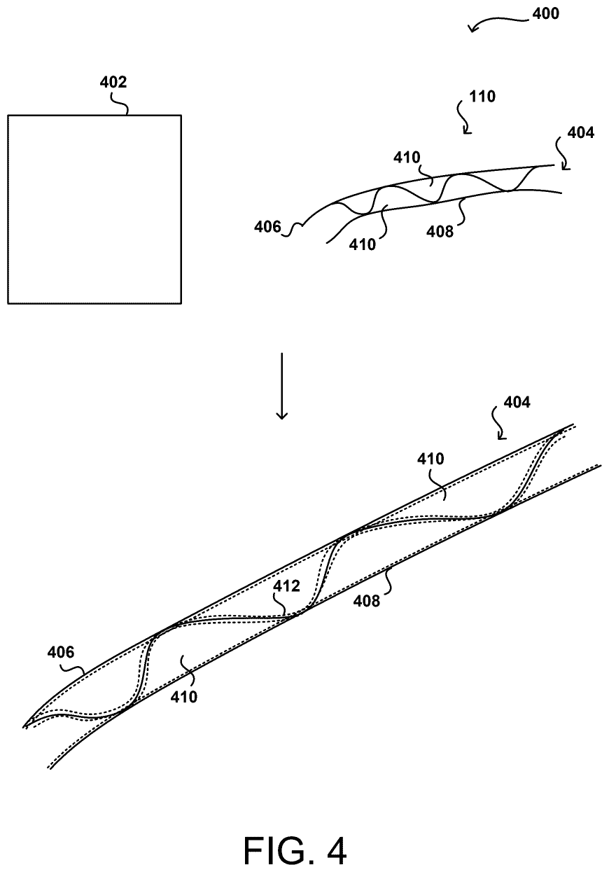

FIG. 4 illustrates an example schematic representation 400 that may be used with embodiments of the present disclosure to apply a washcoat slurry to a substrate to generate a catalyst assembly. In this example, a sheet 402 may be formed into one or more patterns, which in this example includes a corrugated pattern 404 that is positioned between first and second layers 406, 408, which may be rolled plates of the same material as the sheet 402. The corrugated pattern 404 positioned between the layers 406, 408 causes a series of channels 410 to be formed in the substrate 110. In operation, the process stream (e.g., gas, liquid, solid, combinations thereof) may flow through the channels 410.

Systems and methods of the present disclosure may provide the corrugated pattern 404 in a configuration that provides a target or range of cell densities. A high cell density may provide the number of channels 410 desired for the application, but due to the size of the channels, coating may be more difficult. For example, in at least one embodiment, systems and methods may provide the corrugated pattern 404 with between approximately 1,500 cells/square inch and approximately 3,000 cells/square inch. In one or more embodiments, the corrugated pattern 404 may be between approximately 2,400 cells/square inch and approximately 2,700 cells/square inch. The high cell density, as discussed herein, may lead to difficulties with effectively applying the washcoating, which may be increased due to processes discussed herein in which a monolith is coated, as opposed to coating a sheet and then rolling the sheet. Embodiments address and overcome these problems by using the washcoat slurry formation and coating processes described herein.

As discussed herein, embodiments of the present disclosure may be used to coat the substrate 110 with a catalytically active material, and therefore, as the process stream flows through the channels 410, one or more chemical reactions may occur. In this example, a catalytic layer 412 (represented by the dashed lines) is deposited along the corrugated pattern 404. As a result, a cross-sectional area of the channels 410 may be reduced, but as discussed herein, control of the quantity of catalytic material applied may maintain the channels 410 to facilitate flow of the process stream. In this manner, systems and methods of the present disclosure may be used to form catalyst assemblies with a variety of different shapes, properties, and/or the like for a number of different applications.

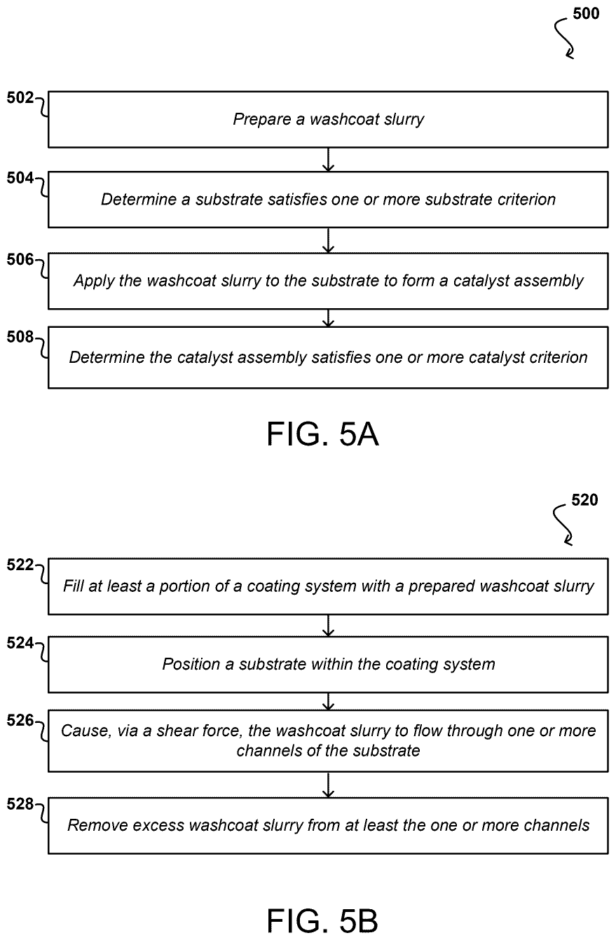

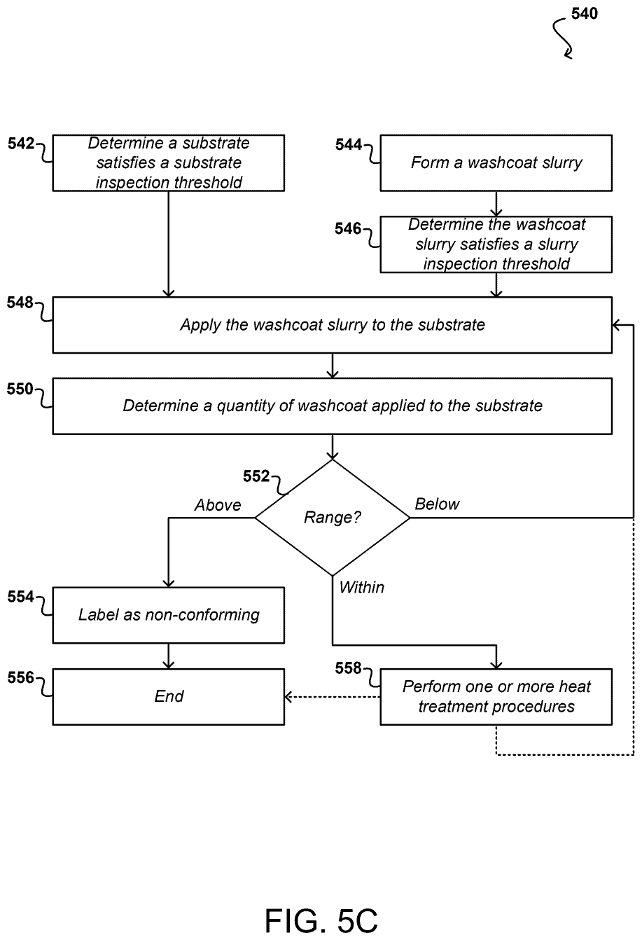

FIG. 5A illustrates an example process 500 to form a catalyst assembly using a washcoat slurry and a substrate, in accordance with various embodiments. It should be understood that for this and other processes presented herein that there may be additional, fewer, or alternative operations performed in similar or alternative orders, or at least partially in parallel, within the scope of the various embodiments unless otherwise specifically stated. In this example, a washcoat slurry is prepared 502. Preparation of the washcoat slurry may include, at least in part, mixing of a washcoat powder, milling of the washcoat powder, incorporation of additives, and/or tuning. The washcoat slurry may be formulated to have one or more target rheological properties, which may enable coating of the channels of one or more substrates. In at least one embodiment, a substrate may be inspected and be determined to satisfy one or more substrate criterion 504. For example, the one or more substrate criterion may include features such as chemical composition of the substrate, surface finish, a shape of the substrate, and/or combinations thereof. The washcoat slurry may be applied to the substrate to form a catalyst assembly 506. The application of the washcoat slurry may include multiple processes or applications, such as an application process within one or more tools, a drying process, a heat treating process, and/or combinations thereof. Furthermore, multiple processes may occur, such as several drying processes, prior to formation of the catalyst assembly. The catalyst assembly may then be determined to satisfy one or more catalyst criterion 508, for example during one or more inspection processes. As a result, the catalyst assembly may be used in one or more downstream operations.

FIG. 5B illustrates an example process 520 to form a catalyst assembly using a coating system, in accordance with various embodiments. In this example, at least a portion of a coating system is filled with a prepared washcoat slurry 522. For example, the coating system may include a piston and cylinder arrangement and the cylinder may be filled, at least in part, with the prepared washcoat slurry. A substrate may be positioned within the coating system 524, such as within a portion of the cylinder, and then the washcoat slurry may be driven to flow through one or more channels of the substrate 526. In the example with the piston and cylinder arrangement, a shear force may be applied to the washcoat slurry, such as by applying a force to the piston, to drive the washcoat slurry through channels formed in the substrate. Excess washcoat slurry may then be removed from at least one of the one or more channels 528, for example by retracting the piston or applying a vacuum.

FIG. 5C illustrates an example process 540 for forming and inspecting a catalyst assembly, in accordance with various embodiments. In this example, it may be determined that a substrate satisfies a substrate inspection threshold 542. For example, the substrate inspection threshold may evaluate material properties of the substrate, surface finish of the substrate, and/or the like. The process may also include preparation steps for a washcoat slurry, which may be done in parallel, or at least partially in parallel, with the inspection of the substrate. Furthermore, each of the inspection and washcoat preparation steps may be performed independently and not in parallel or partially in parallel. For example, several substrates may be evaluated and then stored for later use. Similarly, batches of washcoat slurry may be made and then stored.

In at least one embodiment, a washcoat slurry may be formed 544, for example by milling a powder and then incorporating one or more additives, as discussed herein. The washcoat slurry may be evaluated to determine that the washcoat slurry satisfies a slurry inspection threshold 546, which may be related to one or more rheological properties of the washcoat slurry.

The washcoat slurry may be applied to the substrate 548, for example using one or more coating processes, such as a push/pull configuration to flow the washcoat slurry through channels of the substrate. A quantity of washcoat slurry applied to the substrate may be determined 550, and it may further be determined whether or not the quantity of washcoat slurry is within a range 552. If the quantity is below the range, another application process may be performed. If the quantity exceeds the range, then the part may be labeled as non-conforming 554 and the work on the substrate may end 556. If the quantity is within the range, one or more heat treatment procedures may be performed 558 to form the catalyst assembly. In this manner, different portions of the catalyst assembly procedure may be evaluated and monitored over time to ensure that the end product satisfies desired specifications.

Other variations are within spirit of present description. Thus, while the described techniques are susceptible to various modifications and alternative constructions, certain illustrated embodiments thereof are shown in drawings and have been described above in detail. It should be understood, however, that there is no intention to limit description to specific form or forms described, but on contrary, intention is to cover all modifications, alternative constructions, and equivalents falling within spirit and scope of description, as defined in appended claims.

Use of terms “a” and “an” and “the” and similar referents in context of describing embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Use of any and all examples, or exemplary language (e.g., “such as”) provided herein, is intended merely to better illuminate embodiments of the description and does not pose a limitation on scope of description unless otherwise claimed. No language in specification should be construed as indicating any non-claimed element as essential to practice of the description.

Although descriptions herein set forth example implementations of described techniques, other architectures may be used to implement described functionality, and are intended to be within scope of this description. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are described as exemplary forms of implementing the claims.

What is claimed is:

1. A method to form a catalyst assembly, comprising:
milling a catalytic wash powder to a target particle distribution;
combining the catalytic wash powder with one or more additives;
tuning the combined catalytic wash powder and one or more additives based, at least in part, on one or more rheological properties to form a washcoat slurry;
causing washcoat slurry to flow through one or more channels of a substrate;
causing excess washcoat slurry to be removed from at least a portion of the one or more channels; and
heating the washcoat slurry, combined with the substrate, to form a catalyst assembly.

2. The method of claim 1, wherein washcoat slurry includes at least one of a gamma-aluminum oxide powder, a platinum metal group active catalyst, nitric acid, an aluminum oxide hydroxide suspension, or samarium nitrate hexahydrate.

3. The method of claim 1, further comprising:
cleaning a surface of the substrate; and
oxidizing the surface of the substrate prior to causing the washcoat slurry to flow through the one or more channels.

4. The method of claim 1, wherein the substrate is a plate and further comprising:
forming the plate into a corrugated pattern having a cell density between approximately 1,500 cells per square inch and approximately 3,000 cells per square inch.

5. The method of claim 1, further comprising:
filling at least a first portion of a coating assembly with the washcoat slurry;
arranging the substrate in at least a second portion of the coating assembly;
applying a shear force to the washcoat slurry; and
applying a vacuum force to the substrate.

6. The method of claim 5, wherein the coating assembly includes a piston and a cylinder.

7. The method of claim 1, further comprising:
arranging the catalyst assembly along a process stream for a launch vehicle; and
causing a liquid propellant to contact the catalyst assembly along the process stream.

8. A method, comprising:
generating a washcoat slurry having one or more target rheological properties and including at least one catalytic material;
applying the washcoat slurry to a substrate including one or more channels;
determining a quantity of washcoat slurry added to the substrate is within a range; and
heating the washcoat slurry and the substrate to form a catalyst assembly.

9. The method of claim 8, further comprising:
determining the quantity of washcoat slurry added to the substrate is below a range; and
applying an additional quantity of washcoat slurry to the substrate.

10. The method of claim 8, wherein the washcoat slurry has at least one of a pH between 3.3 and 4.5, a specific gravity between 1.2 and 1.6, and a yield stress between 0.8 and 5 Pascals.

11. The method of claim 8, wherein the range is between 0.07 and 0.13 grams of washcoat per gram of substrate.

12. The method of claim 8, wherein the range is between 0.130 and 0.220 grams of washcoat per gram of substrate.

13. The method of claim 8, wherein the heating is configured to promote adhesion of the washcoat slurry to the substrate and to drive decomposition of a platinum metal group precursor of the washcoat slurry.

14. The method of claim 8, wherein the one or more target rheological properties include at least one of yield stress or viscosity.

15. The method of claim 8, further comprising:
milling a catalytic wash powder to a target particle distribution;
combining the catalytic wash powder with one or more additives; and
tuning the combined catalytic wash powder and one or more additives based, at least in part, on the one or more target rheological properties.

16. The method of claim 8, wherein the substrate is a plate and further comprising:
forming the plate into a corrugated pattern having a cell density between approximately 1,500 cells per square inch and approximately 3,000 cells per square inch, wherein the washcoat slurry is applied after the plate is formed into the corrugated pattern.

17. The method of claim 8, further comprising:
arranging the catalyst assembly along a process stream for a launch vehicle; and
causing a hydrogen peroxide propellant to contact the catalyst assembly along the process stream to generate an exhaust used as thrust for the launch vehicle.

18. A catalyst assembly, comprising:
a substrate including one or more channels; and
an adhered catalyst layer covering at least a portion of the substrate, the adhered catalyst layer including one or more catalytic materials configured to chemically react with a process stream flowing through the one or more channels, wherein the adhered catalyst layer has a threshold catalyst loading.

19. The catalyst assembly of claim 18, wherein the substrate includes at least a ferroalloy and the one or more catalytic materials includes at least a platinum metal group catalyst.

20. The catalyst assembly of claim 18, where the catalyst assembly is configured to be positioned within a process flow stream including a hydrogen peroxide propellant and the one or more catalytic materials are configured to decompose the hydrogen peroxide propellant into a gas to generate thrust.
